(19) United States
(12) Patent Application Publication
(10) Pub. No.: US 2010/0032187 A1
(43) Pub. Date: Feb. 11, 2010

(54) SILICONE RUBBER WITH IMPROVED HYDROPHOBIC STABILITY

(75) Inventors: Xiavier Kornmann, Dubendorf (CH); Henrik Hillborg, Vasteras (SE); Patrick Meier, Staufen (CH); Andrej Krivda, Wettingen (CH)

Correspondence Address: VENABLE LLP, P.O. BOX 34385, WASHINGTON, DC, 20043-9998, US

(73) Assignee: ABB Research Ltd.,, Zurich (CH)

(21) Appl. No.: 12/517,737

(22) PCT Filed: Nov. 28, 2007
(86) PCT No.: PCT/SE07/50910

§ 371 Date: Jun. 4, 2009

(30) Foreign Application Priority Data
Dec. 5, 2006 (SE) 0602640-5

(51) Int. Cl. H01B 17/00; C08L 83/06

(52) U.S. Cl. 174/137 R; 525/477

(57) ABSTRACT

An electrical insulating composition that can be used in high voltage applications. The electrically insulating composition includes silicone rubber and has improved hydrophobic stability over other silicone rubbers. The material is particularly suited to be used in high voltage (>1 kV) composite insulators.

### TECHNICAL AREA

This invention relates to methods and means for producing an electrically insulating material with improved hydrophobic stability. The material is particularly suited to be used in high voltage (>1 kV) composite insulators.

### TECHNICAL BACKGROUND

Silicone rubber is today an accepted and commonly used material for high voltage composite insulators. Its advantages compared to the traditional porcelain and glass insulators are low weight, better performance in polluted environments thanks to their excellent hydrophobic properties. The hydrophobicity if the outdoor insulator is important since it prevents the formation of a continuous water film on the insulator surface.

If the hydrophobicity of the silicone rubber is destroyed temporally due to weather circumstances or to electrical discharges, it gradually recovers afterwards. This ability to recover hydrophobicity after electrical discharges as well as after rapid pollution build-up is a unique property of silicone rubbers. The main mechanism for this hydrophobic recovery is the migration of free silicone oil from the rubber to the surface. These oils are intrinsically present in the rubber as by-products from the polymerization process, but are also generated during degradation processes or specifically added during the compounding of the material.

It has been noted in the field that the standard silicone rubbers used as high voltage outdoor insulation on some occasions exhibited a reduced hydrophobicity after electrical discharges. This reduced hydrophobicity of the standard silicone rubbers used as insulators, occur mostly at extreme conditions such as high humidity and very fast pollution build up.

High voltage in this text refers to voltages over 1000V. In some electro-technical areas one defines medium voltage as being between 1 kV and 50 kV and then the high voltage in this text refers to both medium voltage and high voltage in those areas.

### PRIOR ART

U.S. Pat. No. 6,090,879 entitled “Silicone rubber composition for application as electrical insulation” describes silicone rubber compositions for application as electrical insulation. The composition is made by blending aluminum hydroxide powder into silicone rubber compositions are already known.

Many classes of chemical compound additives have been disclosed in the prior art as effective voltage stabilizers, i.e. suppressants for electrical failure, water-treeing and/or electrical-treeing (microscopic dentrites caused by corona arcing).

U.S. Pat. No. 4,305,849, teaches the use of polyethylene glycols having molecular weights of from about 1,000 to 20,000 as voltage stabilizers.

U.S. Pat. Nos. 4,144,202 and 4,263,158 teach the use of organosilane compounds containing azomethine groups as voltage stabilizers.

U.S. Pat. No. 4,376,180 discloses the use of 3-(N-phenylaminopropyl-tridodecyloxysilane) as a voltage stabilizer.

U.S. Pat. No. 4,440,671 discloses the use of a blend of hydrocarbon-substituted diphenyl amine and a high molecular weight polyethylene glycol for this purpose.

U.S. Pat. No. 4,514,535 discloses the use of tritetrahydrofurfuryloxy phosphite as a voltage stabilizer.

U.S. Pat. No. 4,374,224 discloses the use of an organic carboxylic ester having at least one aromatic ring and at least three carboxylic ester groups as a voltage stabilizer.

U.S. Pat. No. 3,553,348 describes the use of filler minerals such as magnesium silicate, pretreated with alkyl and vinyl alkoxysilanes, as voltage stabilizers.

U.S. Pat. No. 4,689,362 entitled “Stabilized olefin polymer insulating compositions” describes silicone rubber compositions.

### SUMMARY OF THE INVENTION

This invention is based on the discovery that the addition of small amounts (1%-5%) of fluorinated silicone oils to a silicone rubber base can be cured into a highly water-resistant silicone rubber that has excellent electrical properties and in particular has excellent high-voltage electrical insulation properties. The silicone rubber composition in the present invention shows improved hydrophobic stability after corona discharges over a silicon rubber without fluorinated silicone oils added.

According to an embodiment of the invention, silicone rubber base comprises fluorinated silicone oil.

According to an embodiment of the invention, the amount of fluorinated silicone oil added to the silicone rubber base is between 0.1% and 10%

According to an embodiment of the invention, the amount of fluorinated silicone oil added to the silicone rubber base is between 0.5% and 5%

According to an embodiment of the invention, the amount of fluorinated silicone oil added to the silicone rubber base is between 0.7% and 3%

According to an embodiment of the invention, the fluorinated silicone oil is added to increase the hydrophobic stability of the silicone rubber surface during corona discharges.

According to an embodiment of the invention, the fluorinated silicone oil is added to increase the hydrophobic stability of the silicone rubber surface during corona discharges by protecting the rubber surface against oxidation and oxidative crosslinking.

According to an embodiment of the invention, the fluorinated silicone oil added to the silicone rubber base can be any type of partially fluorinated silicone oil.

According to an embodiment of the invention, the fluorinated silicone oil added to the silicone rubber base can be any type of polyalkylsiloxane or polyarylsiloxane oil.

According to an embodiment of the invention, the fluorinated silicone oil added to the silicone rubber base can be any type of; Alkyl Methyl Siloxanes, Cyclohexasiloxane, Cyclopentasiloxane, Disiloxane, Trisiloxane

According to an embodiment of the invention, the fluorinated silicone oil added to the silicone rubber base is 3,3,3-trifluoropropylmethylsiloxane.

According to an embodiment of the invention, the fluorinated silicone oil added to the silicone rubber base is a copolymer of 3,3,3-trifluoropropylmethylsiloxane and dimethylsiloxane.

According to an embodiment of the invention, the fluorinated silicone oil added to said silicone rubber base have a viscosity between 80-120 cSt.

According to an embodiment of the invention, the high voltage is 20 kV and higher.

According to an embodiment of the invention, the insulating silicone rubber composition is molded into insulators which are used in high voltage switchgear

According to an embodiment of the invention, the insulating silicone rubber composition is molded/extruded into hollow core insulators which are used in high voltage transformers.

According to an embodiment of the invention, the insulating silicone rubber composition is molded into hollow core insulators which are used in high voltage circuit breakers.

According to an embodiment of the invention, the insulating silicone rubber composition is molded into insulators which are used in high voltage surge arresters.

According to an embodiment of the invention, the insulating silicone rubber composition is molded into insulators which are used in cutouts for medium voltage.

According to an embodiment of the invention, the insulating silicone rubber composition is used in an electrical apparatus in a high voltage electrical transmission or distribution network and the electrical apparatus has at least one composite insulator, partly made from silicon rubber composition, where said silicone rubber composition comprises fluorinated silicone oil which is added to increase the hydrophobic stability of the silicone rubber surface during corona discharges.

According to an embodiment of the invention, the insulating silicone rubber composition is used in a system for high voltage electrical transmission or distribution with at least one apparatus comprising the list of switchgear, transformers, circuit breakers, surge arresters, cutouts, and at least one apparatus in the system has one or more composite insulators partly made from silicon rubber composition, where said silicone rubber composition comprises fluorinated silicone oil which is added to increase the hydrophobic stability of the silicone rubber surface during corona discharges.

### BRIEF DESCRIPTION OF THE DRAWINGS

The invention will be elucidated by reference to an embodiment partially illustrated in the drawings.

FIG. 1 shows the improved recovery of hydrophobicity after corona discharges according to an embodiment of the present invention, measured as advancing water contact angles.

FIG. 2 shows the improved recovery of hydrophobicity after corona discharges according to an embodiment of the present invention, measured as receding water contact angles.

FIG. 3 shows the results of spraying water on two silicone rubber test pieces after being exposed to 4 hours of corona discharges.

### DETAILED DESCRIPTION OF THE EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

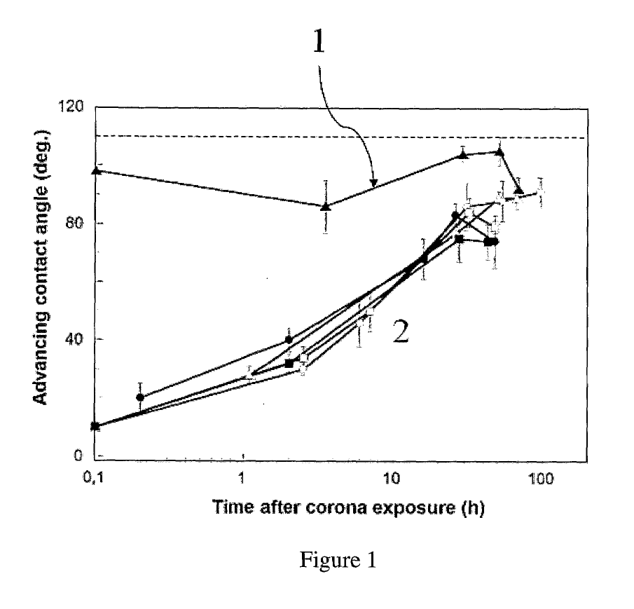

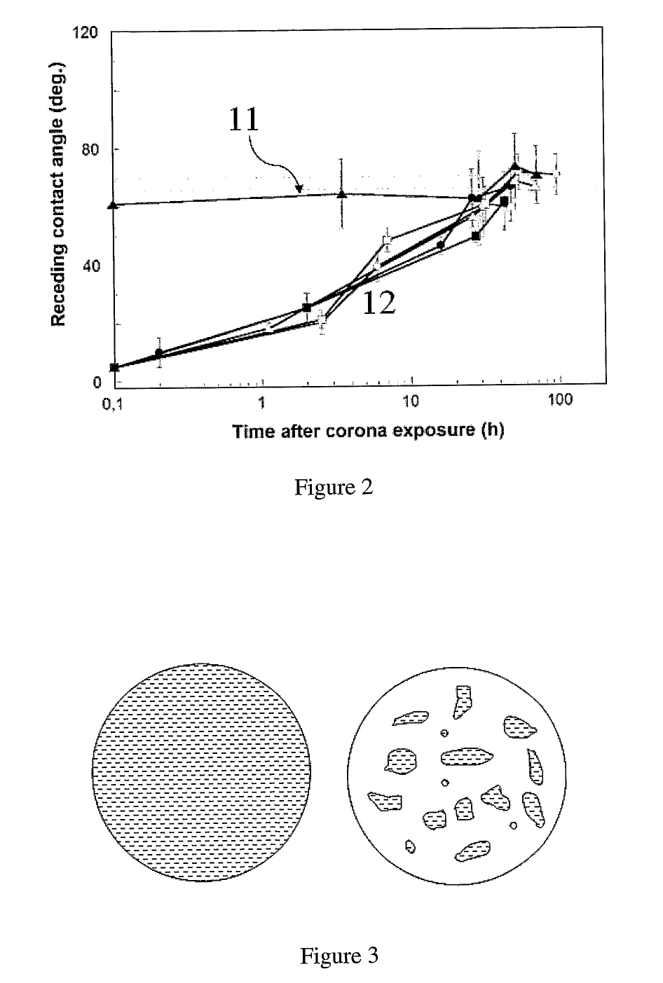

The hydrophobic recovery of silicone rubber after exposure two hours of corona discharges with 20 kV at 0% relative humidity (RH) is shown in FIGS. 1 and 2. The hydrophobicity was assessed by measuring the advancing and receding water contact angles using the sessile drop technique. A Rame′ Hart goniometer was used at ambient conditions. The advancing and receding contact angles were measured on both sides of the drop and on at least six different locations on each sample. The error bars indicate the standard deviation. FIG. 1 shows the measured (as advancing contact angle) results of the recovery of hydrophobicity of silicone rubber with different types of silicone oils added to the rubber.

A contact angle of 0° indicates that the surface is extremely hydrophilic. On hydrophilic surfaces, water droplets will exhibit contact angles of 10° to 30°. On highly hydrophobic surfaces, which are incompatible with water, one observes contact angles of >700. A contact angle of 180° means water droplets simply rest on the surface, without actually wetting the surface, such a surface is called superhydrophobic.

The measurements for the silicone rubber with fluorinated silicone oil 1 added show no reduction in hydrophobicity. Other measurements 2 of silicone rubber without additives and silicone rubber with additives such as silicone oil (in different quantities), cyclic silicones, or phenylated silicone oil show a substantial reduction in hydrophobicity directly after exposure. The hydrophobic recovery of 2 is similar for silicone rubber without or with said additives. One should note that all the silicone rubbers with the exception of the fluorinated silicone oil 2 can be seen as hydrophilic (i.e. contact angle less than 30°) for more than one hour after being exposed to the corona discharges. One can also observe that it takes more that ten hours before the surface of the silicone rubbers without fluorinated silicone oil 2 can be defined as hydrophobic (i.e. contact angle greater than 70°). The surface of the silicone rubber with fluorinated silicone oil 1 remains hydrophobic after being exposed to the corona discharges.

FIG. 2 show the measured (as receding contact angle) results of the recovery of hydrophobicity of silicon rubber with different types of silicone oils added to the rubber.

The measurements for the silicone rubber with fluorinated silicone oil 11 added shows a slight reduction in hydrophobicity. Other measurements 12 of silicone rubber without additives and silicone rubber with additives such as silicone oil (in different quantities), cyclic silicones and phenylated silicone oil show a substantial reduction in hydrophobicity. The hydrophobic recovery of 12 is similar for silicone rubber without or with said additives. One should note that all the silicone rubbers without fluorinated silicone oil 12 can be seen as hydrophilic (i.e. contact angle less than 30°) for more than one hour after being exposed to the corona discharges. One can also observe that it takes more that ten hours before the surface of the silicone rubbers without fluorinated silicone oil 2 can be defined as hydrophobic (i.e. contact angle greater than 70°). The surface of the silicone rubber with fluorinated silicone oil 11 remains hydrophobic after being exposed to the corona discharges.

FIG. 3 shows the result of spraying water on two silicone rubber test pieces exposed to 4 hours of corona discharges. The pieces where sprayed with water 5 minutes after the 4 hours corona discharge test ended. The left test piece is unmodified silicone rubber and the right test piece is silicone rubber containing 2 wt. % fluorinated silicone oil. It is clearly seen that the unmodified silicone rubber (left) is hydrophilic resulting in that the water wets the whole surface. The silicone rubber with fluorinated silicone oil (right) remains hydrophobic and the sprayed on water forms droplets on the surface.

The surfaces of the two test pieces, with reference silicone and with silicone modified with fluorinated silicone oil were investigated using Scanning Electron Microscopy (SEM) after 2*2 hour corona discharge test. The SEM investigation shows that the reference rubber exhibited extensive surface cracking as a result of oxidative crosslinking reactions. The surfaces of silicone rubber modified with fluorinated silicone oil did not exhibit any sign of surface cracking. Thus, the added fluorinated oil act as an effective antioxidant during exposure to corona discharges, resulting in an improved hydrophobic stability

The increased hydrophobic stability of the surface of the silicone rubber with added fluorinated silicone oil would allow design changes to a high voltage insulator. The current design of insulators allows the outer surface to become hydrophilic and even with water film on the surface the insulator performs its function. With guarantees of a continuously hydrophobic surface, the outer surface of the insulator can be reduced.

One example where silicone rubber isolator material is used is in a hollow composite insulator. The hollow composite insulator is made by adding a silicone rubber sheath to make an outer surface to a composite tube.

The silicone rubber isolators in the present invention can be used on a number of different high voltage components used in electrical transmission and distribution system such as; switchgear, transformers, circuit breakers, surge arresters, cutouts.

1. An electrical insulating composition to be used in high voltage (>1 kV) applications, the composition comprising
a silicone rubber base comprising fluorinated silicone oil.

2. The electrical insulating composition to be used in high voltage applications according to claim 1, wherein the amount of fluorinated silicone oil added to the silicone rubber base is between 0.1% and 10%.

3. The electrical insulating composition to be used in high voltage applications according to claim 1, wherein the amount of fluorinated silicone oil added to the silicone rubber base is between 0.5% and 5%.

4. The electrical insulating composition to be used in high voltage applications according to claim 1, wherein the amount of fluorinated silicone oil added to the silicone rubber base is between 0.7% and 3%.

5. The electrical insulating composition to be used in high voltage applications according to claim 1, wherein the fluorinated silicone oil is added to increase the hydrophobic stability of the silicone rubber surface during corona discharges.

6. The electrical insulating composition to be used in high voltage applications according to claim 1, wherein the fluorinated silicone oil is added to increase the hydrophobic stability of the silicone rubber surface during corona discharges by protecting the rubber surface against oxidation and oxidative crosslinking.

7. The electrical insulating composition to be used in high voltage applications according to claim 1, wherein the fluorinated silicone oil added to said silicone rubber base can be any type of partially fluorinated silicone oil.

8. The electrical insulating composition to be used in high voltage applications according to claim 1, wherein the fluorinated silicone oil added to said silicone rubber base can be any type of polyalkylsiloxane or polyarylsiloxane oil.

9. The electrical insulating composition to be used in high voltage applications according to claim 1, wherein the fluorinated silicone oil added to said silicone rubber base can be any type of; Alkyl Methyl Siloxanes, Cyclohexasiloxane, Cyclopentasiloxane, Disiloxane, Trisiloxane.

10. The electrical insulating composition to be used in high voltage applications according to claim 1, wherein the fluorinated silicone oil added to said silicone rubber base is 3,3,3-trifluoropropylmethylsiloxane.

11. The electrical insulating composition to be used in high voltage applications according to claim 1, wherein the fluorinated silicone oil added to said silicone rubber base is a copolymer of 3,3,3-trifluoropropylmethylsiloxane and dimethylsiloxane.

12. The electrical insulating composition to be used in high voltage applications according to claim 1, wherein said fluorinated silicone oil added to said silicone rubber base has a viscosity between 80-120 cSt.

13. The electrical insulating composition to be used in high voltage applications according to claim 1, wherein said high voltage is 20 kV and higher.

14. An electrical apparatus in a high voltage application in an electrical transmission or distribution network, said electrical apparatus comprising:
at least one composite insulator comprising silicon rubber, wherein said silicone rubber comprises fluorinated silicone oil to increase a hydrophobic stability of the silicone rubber surface during corona discharges.

15. The electrical apparatus according to the claim 14, wherein said electrical apparatus is a high voltage switchgear.

16. The electrical apparatus according to the claim 14, wherein said electrical apparatus is a high voltage transformer.

17. The electrical apparatus according to the claim 14, wherein said electrical apparatus is a high voltage circuit breaker.

18. The electrical apparatus according to the claim 14, wherein said electrical apparatus is a high voltage surge arrester.

19. The electrical apparatus according to the claim 14, wherein said electrical apparatus is a cutout for high voltage.

20. A system for high voltage electrical transmission or distribution, the system comprising:
at least one apparatus of switchgear, transformers, circuit breakers, surge arresters, cutouts, wherein said system has at least one apparatus with
at least one composite comprising silicon rubber, the silicone rubber comprising fluorinated silicone oil to increase a hydrophobic stability of the silicone rubber surface during corona discharges.
